(19) United States
(12) Patent Application Publication
(10) Pub. No.: US 2018/0297552 A1
(43) Pub. Date: Oct. 18, 2018

(54) WEBBING TAKE-UP DEVICE AND MANUFACTURING METHOD THEREOF

(71) Applicant: KABUSHIKI KAISHA TOKAI-RIKA-DENKI-SEISAKUSHO, Aichi-ken (JP)

(72) Inventor: Wataru YANAGAWA, Aichi-ken (JP)

(21) Appl. No.: 15/949,606

(22) Filed: Apr. 10, 2018

(30) Foreign Application Priority Data
Apr. 14, 2017 (JP) 2017-080565

(51) Int. Cl. B60R 22/34; B60R 22/28

(52) U.S. Cl. CPC B60R 22/341; B60R 2022/287; B60R 22/28

(57) ABSTRACT

In a webbing take-up device, a first rotation section and a second rotation section are coupled by forming a first detachment prevention portion at a vehicle rear side end portion of a circular cylinder portion of the second rotation section. Moreover, a mounting portion of a torsion bar is inserted inside the vehicle rear side end portion of the circular cylinder portion in this state. This enables deformation of the vehicle rear side end portion of the circular cylinder portion to be suppressed, and enables deformation of the first detachment prevention portion to be suppressed.

### CROSS-REFERENCE TO RELATED APPLICATION

This application claims priority under 35 USC 119 from Japanese Patent Application No. 2017-080565 filed Apr. 14, 2017, the disclosure of which is incorporated by reference herein.

### BACKGROUND

### Field of the Invention

The present disclosure relates to a webbing take-up device capable of rotating a spool in a take-up direction by a rotating member being rotated, and a manufacturing method for the webbing take-up device.

### Related Art

For example, in a pre-tensioner disclosed in Japanese Patent Application Laid-Open (JP-A) No. 2012-101774, a caulked portion is provided on a coupling boss of an inner ring, thus forming a pre-tensioner in which the inner ring and the outer ring are coupled together. In such a configuration, there is a possibility of the caulked portion deforming as a result of load acting on the caulked portion.

### SUMMARY

In consideration of the above circumstances, a webbing take-up device capable of suppressing deformation of a first restriction section that couples a first rotation section and a second rotation section together, and a manufacturing method for the webbing take-up device, are obtained.

A webbing take-up device of a first aspect is a webbing take-up device including: a spool that takes up a webbing by being rotated in a take-up direction; a first rotation section that rotates the spool in the take-up direction by being rotated in a predetermined direction; a second rotation section that opposes the first rotation section, and that is connected to the first rotation section so as to be capable of rotating integrally with the first rotation section; a first restriction section that is provided at one of the first rotation section or the second rotation section, that restricts relative movement of the first rotation section and the second rotation section in a direction away from each other, and that couples the first rotation section and the second rotation section; and a mounted member that is mounted to the one of the first rotation section or the second rotation section, and that suppresses deformation of the first restriction section.

In the webbing take-up device of the first aspect, the mounted member is mounted to the one of the first rotation section or the second rotation section, and deformation of the first restriction section provided at the one of the first rotation section or the second rotation section is suppressed by the mounted member. This enables deformation of the first restriction section to be suppressed.

A webbing take-up device of a second aspect is the webbing take-up device of the first aspect, wherein the first restriction section is configured by a deformation portion of the one of the first rotation section or the second rotation section.

According to the webbing take-up device of the second aspect, the first restriction section is configured by the deformation portion of the one of the first rotation section or the second rotation section. Thus, there is no need for a special separate component which is just for the first restriction section and which is another member other than the first rotation section and the second rotation section.

A webbing take-up device of a third aspect is the webbing take-up device of the second aspect, wherein the first restriction section is configured by the deformation portion of the one of the first rotation section or the second rotation section, which is deformed by the mounted member.

According to the webbing take-up device of the third aspect, the first restriction section is the deformation portion of the one of the first rotation section or the second rotation section deformed by the mounted member. There is accordingly no need for a dedicated component or the like which is just for forming the first restriction section and which is a member other than the mounted member.

A webbing take-up device of a fourth aspect is the webbing take-up device of any one of the first aspect to the third aspect, wherein the mounted member is deformed by rotation of the spool in a pull-out direction that is opposite from the take-up direction, whereby the mounted member absorbs rotational force of the spool in the pull-out direction.

In the webbing take-up device of the fourth aspect, there is no need for a member which is just for forming the first restriction section and which is a member other that a member to absorb rotational force of the spool in the pull-out direction.

A webbing take-up device of a fifth aspect is the webbing take-up device of any one of the first aspect to the fourth aspect, wherein the first restriction section is configured by a deformation portion of the one of the first rotation section or the second rotation section, which is deformed in a direction orthogonal to a rotation axis of the one of the first rotation section or the second rotation section by the mounted member.

According to the webbing take-up device of the fifth aspect, the first restriction section is configured by the deformation portion formed by the one of the first rotation section or the second rotation section being deformed in the rotation axis-orthogonal direction by the mounted member. Thus the first restriction section can be formed by mounting the mounted member to the one of the first rotation section or the second rotation section.

A webbing take-up device of a sixth aspect is the webbing take-up device of any one of the first aspect to the fifth aspect, wherein the first restriction section is configured by a deformation portion of the one of the first rotation section or the second rotation section, which is deformed by a portion of the mounted member that is different from a mounted portion of the mounted member, the mounted portion being mounted to the one of the first rotation section or the second rotation section.

According to the webbing take-up device of the sixth aspect, the first restriction section is a deformation portion of the one of the first rotation section or the second rotation section, which is deformed by a portion of the mounted member that is different from a mounted portion of the mounted member, the mounted portion being mounted to the one of the first rotation section or the second rotation section. Therefore, when the first restriction section is being formed, deformation or the like of the mounted portion of the mounted member mounted to the one of the first rotation section or the second rotation section can be suppressed from occurring.

A webbing take-up device of a seventh aspect is the webbing take-up device of any one of the first aspect to the sixth aspect, further including a second restriction section that restricts movement of the mounted member in an opposite direction from a mounting direction of the mounted member with respect to the one of the first rotation section or the second rotation section in a mounted state of the mounted member to the one of the first rotation section or the second rotation section.

According to the webbing take-up device of the seventh aspect, in a state in which the mounted member is mounted to the one of the first rotation section or the second rotation section, movement of the mounted member in the opposite direction to the mounting direction is restricted by the second restriction section. This enables the mounted state of the mounted member to the one of the first rotation section or the second rotation section to be maintained.

A webbing take-up device according to an eighth aspect is the webbing take-up device of the seventh aspect, wherein the mounted member includes a housing portion that houses the second restriction section, and the second restriction section opposes the mounted member from a side that is opposite from the mounting direction, in a state in which the second restriction section is housed in the housing portion.

According to the webbing take-up device of the eighth aspect, the second restriction section opposes the mounted member from the opposite side to the mounting direction in a state in which the second restriction section is housed in the housing portion of the mounted member. This enables movement of the mounted member in the opposite direction to the mounting direction to be restricted by the second restriction section.

A webbing take-up device according to a ninth aspect is the webbing take-up device of the seventh aspect or the eighth aspect, wherein the second restriction section is configured by another deformation portion of one of the first rotation section or the second rotation section.

According to the webbing take-up device of the ninth aspect, the second restriction section is the another deformation portion of the one of the first rotation section or the second rotation section. There is accordingly no need for a special component which is just for the second restriction section and which is a member other than the first rotation section and the second rotation section.

A webbing take-up device of a tenth aspect is the webbing take-up device of the ninth aspect, wherein the second restriction section is configured by the another deformation portion of the one of the first rotation section or the second rotation section, which is deformed by the mounted member.

According to the webbing take-up device of the tenth aspect, the second restriction section is the another deformation portion of the one of the first rotation section or the second rotation section caused by mounting the mounted member to the one of the first rotation section or the second rotation section. There is accordingly no need for a dedicated component or the like which is just to form the second restriction section and which is a member other than the mounted member.

A manufacturing method for a webbing take-up device of an eleventh aspect is a manufacturing method for a webbing take-up device, the webbing take-up device including: a spool that takes up a webbing by being rotated in a take-up direction; a first rotation section that rotates the spool in the take-up direction by being rotated in a predetermined direction; a second rotation section that opposes the first rotation section, and that is connected to the first rotation section so as to be capable of rotating integrally with the first rotation section; a first restriction section that is provided at one of the first rotation section or the second rotation section, that restricts relative movement of the first rotation section and the second rotation section in a direction away from each other, and that couples the first rotation section and the second rotation section; and a mounted member that is mounted to the one of the first rotation section or the second rotation section, that suppresses deformation of the first restriction section, and that is deformed by rotation of the spool in a pull-out direction that is opposite from the take-up direction, whereby the mounted member absorbs rotational force of the spool in the pull-out direction, the manufacturing method comprising: mounting the mounted member to the one of the first rotation section or the second rotation section in a state in which the first rotation section and the second rotation section are disposed opposing each other; and by mounting the mounted member to the one of the first rotation section or the second rotation section, deforming the one of the first rotation section or the second rotation section to form the first restriction section so as to suppress deformation of the first restriction section.

According to the webbing take-up device manufacturing method of the eleventh aspect, the one of the first rotation section or the second rotation section is deformed so as to form the first restriction section, by mounting the mounted member to the one of the first rotation section or the second rotation section disposed opposing each other. Moreover, deformation of the first restriction section is suppressed by the mounted member mounted to the one of the first rotation section or the second rotation section. This enables deformation of the first restriction section to be suppressed.

As explained above, the webbing take-up device according to the present disclosure, and the manufacturing method of the webbing take-up device according to the present disclosure, enable deformation of the first restriction section coupling the first rotation section and the second rotation section together to be suppressed from occurring.

### BRIEF DESCRIPTION OF THE DRAWINGS

Exemplary embodiments will be described in detail with reference to the following figures, wherein:

FIG. 1 is an exploded perspective view illustrating relevant portions of a webbing take-up device according to a first exemplary embodiment;

FIG. 2 is an enlarged exploded perspective view illustrating a spool, a torsion bar, and a rotating member as viewed from a vehicle lower side;

FIG. 3A is a cross-section of the spool, the torsion bar, and the rotating member as taken along line 3-3 in FIG. 2;

FIG. 3B is an enlarged cross-section of the portion inside the circle D in FIG. 3A;

FIG. 3C is an enlarged perspective view illustrating a vehicle front side portion of the torsion bar;

FIG. 4 is a cross-section of the rotating member and the torsion bar as taken along line 3-3 in FIG. 2, illustrating an abutted state of an outer circumferential portion of a taper of a mounting portion of the torsion bar against a vehicle rear side end of an inner circumferential portion of a circular cylinder portion of a second rotation section;

FIG. 5 is a cross-section corresponding to FIG. 4, illustrating a state in which the circular cylinder portion of the second rotation section has been deformed by an outer circumferential portion of the taper of the mounting portion of the torsion bar;

FIG. 6 is a cross-section corresponding to FIG. 5, illustrating state in which a first detachment prevention portion has been formed to the circular cylinder portion of the second rotation section;

FIG. 7A to FIG. 7C illustrate a second exemplary embodiment, and are cross-sections and a perspective view corresponding to FIG. 3A to FIG. 3C;

FIG. 8 is a cross-section corresponding to FIG. 4, illustrating a state in which a torsion bar and a rotating member are disposed opposing each other;

FIG. 9 is a cross-section corresponding to FIG. 8, illustrating a state in which an inner circumferential portion of a small diameter portion of a circular cylinder portion of a second rotation section has been deformed;

FIG. 10 is a cross-section corresponding to FIG. 9, illustrating a state in which a large diameter portion of the circular cylinder portion of the second rotation section has been deformed; and

FIG. 11 is a cross-section corresponding to FIG. 10, illustrating state in which a first detachment prevention portion and a second detachment prevention portion have been formed on the circular cylinder portion of the second rotation section.

### DETAILED DESCRIPTION

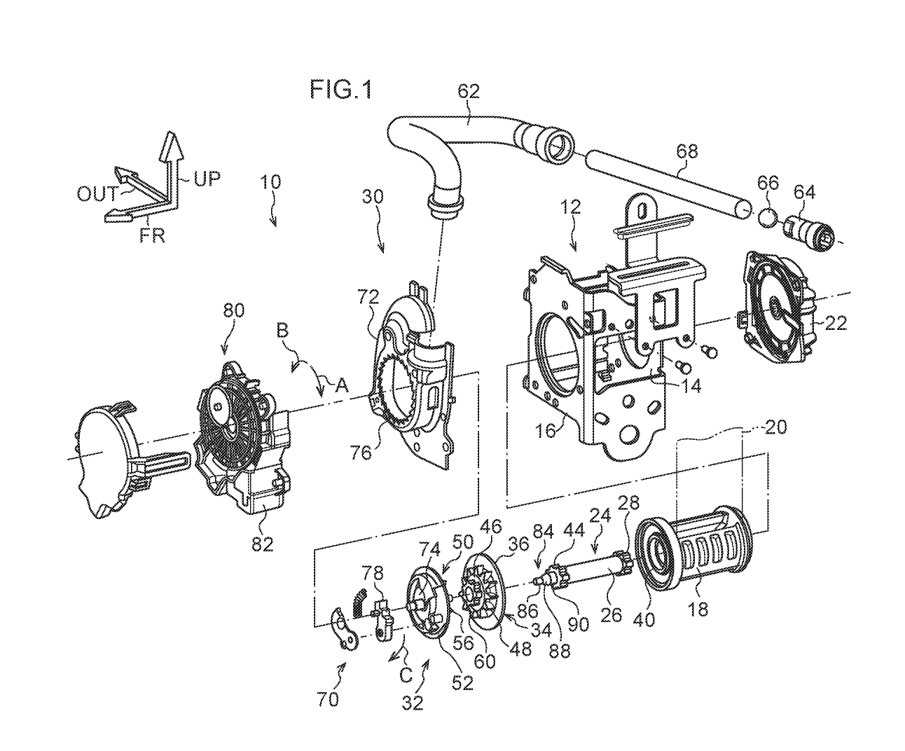

Explanation follows regarding exemplary embodiments of the present invention, with reference to FIG. 1 to FIG. 11. In each of the drawings, the arrow FR indicates the front side, the arrow OUT indicates a vehicle width direction outside, and the arrow UP indicates a vehicle upper side of a vehicle applied with a webbing take-up device 10. Moreover, in each of the drawings, the arrow A indicates a take-up direction, this being one rotation direction side of a spool 18 and the like, and the arrow B indicates a pull-out direction, this being the opposite direction to the take-up direction. The arrow C in each of the drawings indicates a locking direction, this being a rotation direction of a locking pawl 78.

### First Exemplary Embodiment Configuration

As illustrated in FIG. 1, a webbing take-up device 10 according to a first exemplary embodiment includes a frame 12. The frame 12 is fixed to a vehicle lower side portion of a center pillar (not shown in the drawings), serving as a vehicle body. The frame 12 is provided with leg plates 14, 16. The leg plate 14 and the leg plate 16 face each other substantially along a vehicle front-rear direction.

The webbing take-up device 10 also includes a spool 18. The spool 18 is formed in a substantially circular cylinder shape, and is disposed between the leg plate 14 and the leg plate 16 of the frame 12. A center axis direction of the spool 18 runs in the direction in which the leg plate 14 and the leg plate 16 face each other (namely, substantially in the vehicle front-rear direction), and the spool 18 is capable of rotating about the center axis direction.

A length direction base end portion of an elongated strap-shaped webbing 20 is anchored to the spool 18. When the spool 18 is rotated in the take-up direction (the arrow A direction in FIG. 1, etc.), the webbing 20 is taken up onto the spool 18 from a length direction base end side. A length direction leading end side of the webbing 20 extends from the spool 18 toward the vehicle upper side. The length direction leading end side of the webbing 20 passes through a slit formed in a through anchor (not shown in the drawings) supported by the center pillar at the vehicle upper side of the frame 12, and folds back toward the vehicle lower side.

A length direction leading end portion of the webbing 20 is anchored to an anchor plate (not shown in the drawings). The anchor plate is formed from a metal plate material such as iron, steel, and is fixed to the vehicle floor (not shown in the drawings) or fixed to a seat (not shown in the drawings) corresponding to the webbing take-up device 10.

A vehicle seatbelt device applied with the webbing take-up device 10 includes a buckle device (not shown in the drawings). The buckle device is provided at the vehicle width direction inside of the seat applied with the webbing take-up device 10. A tongue (not shown in the drawings) provided to the webbing 20 is engaged with the buckle device in a state in which the webbing 20 has been entrained around the body of an occupant sitting in the seat, such that the webbing 20 is applied over the body of the occupant.

As illustrated in FIG. 1, a spring housing 22 is provided at the vehicle rear side of the leg plate 14 of the frame 12. A spool urging member such as a spiral spring (not shown in the drawings) is provided inside the spring housing 22. The spool urging member is directly or indirectly engaged with the spool 18, and the spool 18 is urged in the take-up direction (the arrow A direction in FIG. 1) by urging force of the spool urging member.

The webbing take-up device 10 includes a torsion bar 24 configuring a force limiter mechanism, which serves as an energy absorption member, and also serving as a mounted member. The torsion bar 24 includes a rod 26. The rod 26 is formed in an elongated rod shape running substantially in the vehicle front-rear direction. A first coupling portion 28 is provided at the vehicle rear side of the rod 26. The first coupling portion 28 is, for example, formed in a spline shape as viewed along the vehicle front-rear direction. The first coupling portion 28 is coupled to a vehicle rear side portion of the spool 18 at the inside of the spool 18, and is restricted from rotating relative to the spool 18.

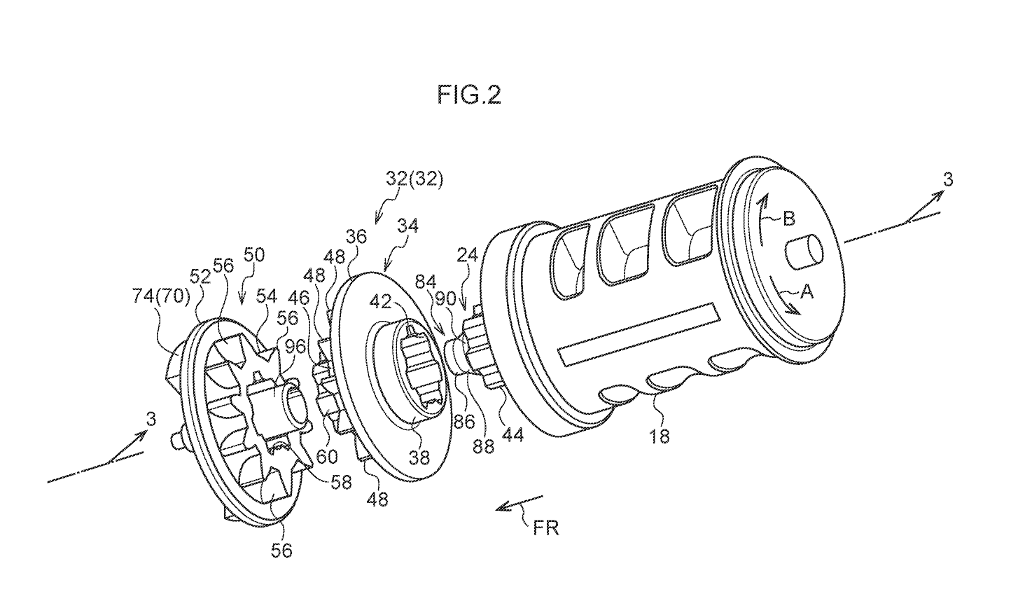

A rotating member 32 of a pre-tensioner 30 is provided at the vehicle front side of the leg plate 16 of the frame 12. The rotating member 32 includes a first rotation section 34. The first rotation section 34 is disposed coaxially to the spool 18. The first rotation section 34 is provided with a first flange 36. The first flange 36 is configured in a disc shape, and is disposed coaxially to the spool 18. As illustrated in FIG. 2, a first insertion portion 38 is provided at a vehicle rear side of the first flange 36. The first insertion portion 38 is configured with a circular outer circumferential profile, and the first insertion portion 38 is disposed coaxially to the spool 18.

A support hole 40 in the spool 18 is formed corresponding to the first insertion portion 38. The support hole 40 is configured with a circular inner circumferential profile, and the support hole 40 is disposed coaxially to the spool 18. The first insertion portion 38 of the first rotation section 34 is inserted into the support hole 40 in the spool 18, and is thus supported so as to be capable of rotating relative to the spool 18.

The first rotation section 34 is formed with a first rotation stop hole 42. The first rotation stop hole 42 is, for example, configured with a spline shaped inner peripheral profile when viewing the first rotation stop hole 42 along the vehicle front-rear direction, and the first rotation stop hole 42 is open at a vehicle rear side end of the first insertion portion 38. The vehicle front side of the rod 26 of the torsion bar 24 is provided with a second coupling portion 44 corresponding to the first rotation stop hole 42. The second coupling portion 44 is configured with an outer peripheral profile of the same shape as the inner peripheral profile of the first rotation stop hole 42 (strictly speaking, a similar shape that is smaller than the inner peripheral profile of the first rotation stop hole 42).

The second coupling portion 44 is inserted into the first rotation stop hole 42, thereby restricting relative rotation of the first insertion portion 38 (namely, the first rotation section 34 of the rotating member 32) with respect to the second coupling portion 44 (namely, the torsion bar 24). As described above, relative rotation of the torsion bar 24 with respect to the spool 18 is restricted, such that relative rotation of the first rotation section 34 of the rotating member 32 with respect to the spool 18 is restricted.

A first engagement portion 46 is provided at the vehicle front side of the first flange 36. The first engagement portion 46 is disposed coaxially to the spool 18. Plural first engagement teeth 48 are provided at an outer circumferential portion of the first engagement portion 46. The first engagement teeth 48 are formed at predetermined intervals around the center axis of the first flange 36, and a vehicle rear side end of each of the first engagement teeth 48 is integrally connected to the first flange 36.

Moreover, a second rotation section 50, which configures the rotating member 32 together with the first rotation section 34, is provided at a vehicle front side of the first rotation section 34. The second rotation section 50 includes a second flange 52. The second flange 52 is configured in a disc shape, and is disposed coaxially to the spool 18. A second engagement portion 54 is provided at the vehicle rear side of the second flange 52. The second engagement portion 54 is disposed coaxially to the spool 18. Plural second engagement teeth 56 are provided at an outer circumferential portion of the second engagement portion 54.

The second engagement teeth 56 are formed at predetermined intervals around the center axis of the second flange 52. The intervals between neighboring second engagement teeth 56 around the center axis of the second rotation section 50 are the same as the intervals between neighboring first engagement teeth 48 of the first rotation section 34 around the center axis of the first rotation section 34 of the rotating member 32. A vehicle front side end of each of the second engagement teeth 56 is integrally connected to the second flange 52.

The second engagement portion 54 is also formed with a second rotation stop hole 58. The second rotation stop hole 58 is open at a vehicle rear side end of the second engagement portion 54. The second rotation stop hole 58 is, for example, configured with a spline-shaped inner circumferential profile. The first rotation section 34 is provided with a second insertion portion 60 corresponding to the second rotation stop hole 58. The second insertion portion 60 is, for example, configured with a spline-shaped outer circumferential profile, and the second insertion portion 60 is disposed coaxially to the spool 18. The second insertion portion 60 is configured with an outer circumferential profile of the same shape as the inner peripheral profile of the second rotation stop hole 58 (strictly speaking, a similar shape that is smaller than the inner circumferential profile of the second rotation stop hole 58).

The second insertion portion 60 is inserted inside the second rotation stop hole 58, thereby restricting relative rotation of the second insertion portion 60 (namely, the second rotation section 50) with respect to the first rotation section 34. Since relative rotation of the first rotation section 34 with respect to the spool 18 is restricted as described above, relative rotation of the second rotation section 50 with respect to the spool 18 is also restricted. In this manner, in a state in which the second insertion portion 60 has been inserted inside the second rotation stop hole 58, each of the second engagement teeth 56 of the second engagement portion 54 are disposed around the center axis of the first rotation section 34 so as to arranged substantially at the center of respective neighboring first engagement teeth 48 of the first rotation section 34, as viewed along the center axis direction of the rotating member 32.

The webbing take-up device 10 further includes a cylinder 62, serving as a tubular member, that configures the pre-tensioner 30 together with the rotating member 32. The cylinder 62 is formed in a circular tube shape. A center axis direction base end portion of the cylinder 62 is disposed at the vehicle upper and rear side of the frame 12. A micro gas generator 64 (hereafter, the micro gas generator 64 is referred to as the MGG 64), configuring a load generator that serves as a fluid pressure generator, is inserted into the center axis direction base end portion of the cylinder 62. The MGG 64 is electrically connected to a collision detection sensor via an ECU (neither shown in the drawings) that serves as a controller provided to the vehicle. The MGG 64 is actuated by the ECU when shock is detected by the collision detection sensor in a vehicle collision, and gas, an embodiment of a fluid generated by the MGG 64, is supplied to inside the cylinder 62.

A seal ball 66, serving as a piston, is disposed at the inside of the cylinder 62 of the pre-tensioner 30. The ball seal 66 is formed from a synthetic resin. The ball seal 66 has a substantially spherical shape in a state in which load is not being imparted to the ball seal 66. The ball seal 66 partitions an internal space of the cylinder 62 into a center axis direction base end side of the ball seal 66 and a center axis direction leading end side of the ball seal 66. When the MGG 64 is actuated, gas generated by the MGG 64 is supplied between the MGG 64 and the ball seal 66 in the cylinder 62. The internal pressure of the cylinder 62 between the MGG 64 and the ball seal 66 accordingly rises, and the ball seal 66 moves toward the center axis direction leading end side of the cylinder 62, and is compressed in the center axis direction of the cylinder 62 and deformed thereby.

A moving member 68 is disposed inside the cylinder 62 of the pre-tensioner 30. The moving member 68 is formed in a circular column shape from a synthetic resin, and is capable of deforming when subjected to external force. The moving member 68 is disposed further toward the center axis direction leading end side of the cylinder 62 than the ball seal 66. When the ball seal 66 moves toward the center axis direction leading end side of the cylinder 62, the moving member 68 is pressed by the ball seal 66 and is moved toward the center axis direction leading end side of the cylinder 62.

The cylinder 62 of the pre-tensioner 30 is bent at a center axis direction intermediate portion, and the center axis direction leading end portion of the cylinder 62 is disposed at the vehicle upper front side of the leg plate 16 of the frame 12. A cover plate 72, serving as a guide member configuring both the locking mechanism 70 and the pre-tensioner 30, is fixed to a vehicle front side of the leg plate 16 of the frame 12. The center axis direction leading end portion of the cylinder 62 is retained clamped between the cover plate 72 and the leg plate 16 of the frame 12. The center axis direction leading end portion of the cylinder 62 is open substantially toward the vehicle lower side (more specifically, toward a side inclined toward the vehicle width direction outside with respect to the vehicle lower side). When the moving member 68 reaches the center axis direction leading end portion of the cylinder 62, the moving member 68 is moved further by being pressed by the ball seal 66, and is projected out from the center axis direction leading end portion of the cylinder 62 toward the vehicle lower side. The moving member 68 projected out in this manner, from the center axis direction leading end portion of the cylinder 62 toward the vehicle lower side, is guided by an inside face of the cover plate 72 and moved toward the vehicle lower side.

Moreover, the rotating member 32 described above is disposed inside the cover plate 72 further toward the substantially vehicle lower side than the center axis direction leading end portion of the cylinder 62 (more specifically, at a side inclined toward the vehicle width direction outside with respect to the vehicle lower side). When the moving member 68 pressed by the ball seal 66 is moved substantially toward the vehicle lower side of the center axis direction leading end portion of the cylinder 62, the moving member 68 enters between the first flange 36 of the first rotation section 34 of the rotating member 32, and the second flange 52 of the second rotation section 50 of the rotating member 32. The moving member 68 abuts the first engagement teeth 48 of the first rotation section 34 in the rotating member 32 or the second engagement teeth 56 of the second rotation section 50 in the rotating member 32. The first engagement teeth 48 or the second engagement teeth 56 are pressed toward the vehicle lower side by the moving member 68.

As a result, the rotating member 32 is rotated in the take-up direction (the arrow A direction in FIG. 1, etc.), and the moving member 68 is moved further toward the vehicle lower side under the pressure from the ball seal 66. In this manner, the rotating member 32 is rotated in the take-up direction by the moving member 68 being moved toward the vehicle lower side, and the first engagement teeth 48 of the first rotation section 34 in the rotating member 32 or the second engagement teeth 56 of the second rotation section 50 in the rotating member 32 stick into the moving member 68. The rotating member 32 is rotated further in take-up direction as the moving member 68 is moved further toward the vehicle lower side in this state.

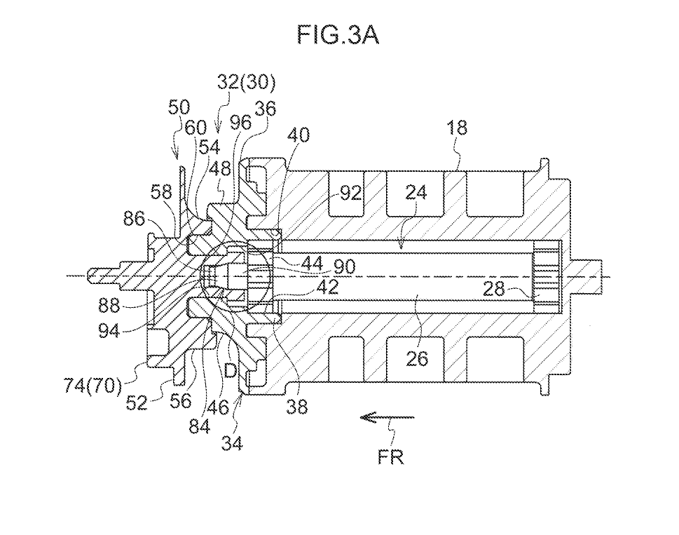

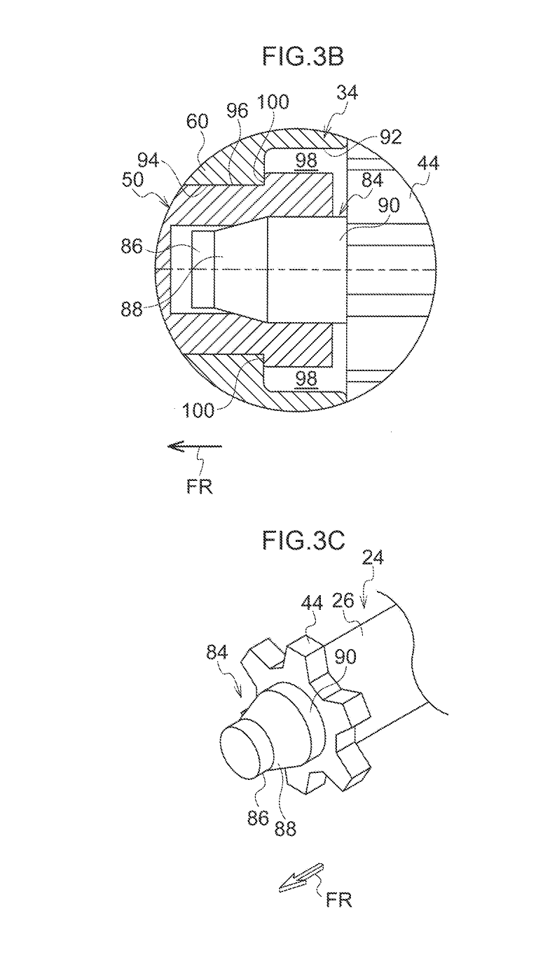

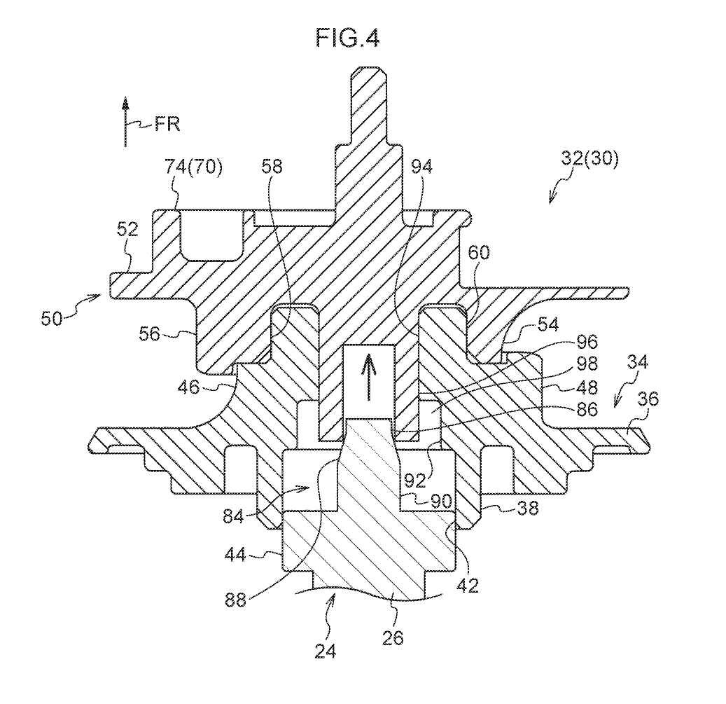

As illustrated in FIG. 2 and FIG. 3A, a portion of the second rotation section 50 of the rotating member 32 located further toward the vehicle front side than the second flange 52 configures a lock base 74 of the locking mechanism 70. As illustrated in FIG. 1, a ratchet hole 76 is formed in the cover plate 72 described above so as to correspond to the lock base 74. The ratchet hole 76 is formed coaxially to the rotating member 32, and the lock base 74 is disposed inside the ratchet hole 76.

The lock base 74 is provided with the locking pawl 78, serving as a lock member. The locking pawl 78 is supported on the lock base 74 so as to be capable of rotating in a locking direction (the arrow C direction in FIG. 1), this being a direction about an axial direction running in the same direction as the center axis of the spool 18. When the locking pawl 78 is rotated in the locking direction, a leading end portion of the locking pawl 78 approaches the ratchet hole 76 in the cover plate 72, and ratchet teeth formed to the leading end portion of the locking pawl 78 mesh with ratchet teeth of the ratchet hole 76. Rotation of the lock base 74 (namely, the rotating member 32) in the pull-out direction (the arrow B direction in FIG. 1, etc.) is thus restricted.

As illustrated in FIG. 1, a sensor holder 82 of a sensor mechanism 80 is provided at the vehicle front side of the cover plate 72. The sensor holder 82 is configured in a box shape opening toward the vehicle rear side, and is fixed to the cover plate 72, or to the leg plate 16 of the frame 12. The sensor holder 82 is provided with other configuration components of the sensor mechanism 80, which is actuated in a vehicle emergency such as a vehicle collision. In an actuated state of the sensor mechanism 80, the locking pawl 78 is rotated in the locking direction by the lock base 74 being rotated in the pull-out direction.

Note that as illustrated in FIG. 1 to FIG. 3C, a mounting portion 84 is provided at the vehicle front side portion of the second coupling portion 44 of the torsion bar 24. The mounting portion 84 includes a first circular column portion 86. The first circular column portion 86 is formed in a circular column shape, and is provided coaxially to the spool 18. A taper portion 88 is provided at the vehicle rear side of the first circular column portion 86. As illustrated in FIG. 3C, the taper portion 88 is configured in a truncated cone shape, and the diameter dimension of an outer circumferential portion of the taper portion 88 becomes smaller on progression toward the vehicle front side. The taper portion 88 is disposed coaxially to the first circular column portion 86, and the diameter dimension of the outer circumferential portion of a vehicle front side end of the taper portion 88 is equal to the diameter dimension of an outer circumferential portion of the first circular column portion 86. The vehicle front side end of the taper portion 88 is integrally connected to a vehicle rear side end of the first circular column portion 86.

A second circular column portion 90 is provided at the vehicle rear side of the taper portion 88. The second circular column portion 90 is configured in a circular column shape, and is disposed coaxially to the first circular column portion 86 and the taper portion 88.

The diameter dimension of an outer circumferential portion of the second circular column portion 90 is equal to the diameter dimension of the outer circumferential portion of the vehicle rear side end of the taper portion 88, and a vehicle front side end of the second circular column portion 90 is integrally connected to the vehicle rear side end of the taper portion 88. A vehicle rear side end of the second circular column portion 90 is integrally connected to a vehicle front side end of the second coupling portion 44 of the torsion bar 24.

The first rotation section 34 of the rotating member 32 is formed with a first hole portion 92. The first hole portion 92 is provided at the vehicle front side with respect to the first rotation stop hole 42 of the first rotation section 34. Moreover, an inner circumferential profile of the first hole portion 92 is circular, and the first hole portion 92 is disposed coaxially to the spool 18. A radial dimension of an inner circumferential portion of the first hole portion 92 is set smaller than the length which is from the center of the first rotation stop hole 42 to the most distant position from the center of the first rotation stop hole 42 at an inner circumferential potion of the first rotation stop hole 42. A vehicle rear side end of the first hole portion 92 opens onto a vehicle front side end of the first rotation stop hole 42 (the bottom portion of the first rotation stop hole 42), such that the first hole portion 92 is connected to the first rotation stop hole 42.

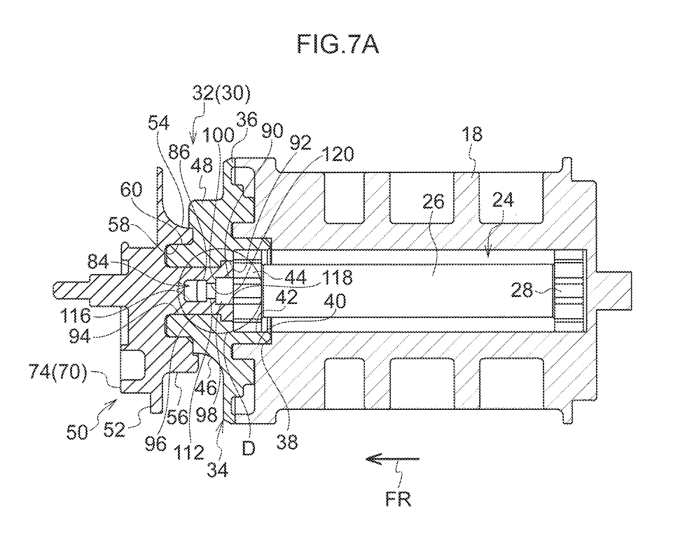

Moreover, as illustrated in FIG. 3A and FIG. 6, the vehicle front-rear direction dimensions and the like of the first hole portion 92 and the second circular column portion 90 are set such that, in a state in which the vehicle front side end of the second coupling portion 44 of the torsion bar 24 is abutted on the vehicle front side end of the first rotation stop hole 42 (the bottom of the first rotation stop hole 42) so the torsion bar 24 is mounted to the rotating member 32, the vehicle rear side end of the first hole portion 92 and the vehicle rear side end of the second circular column portion 90 of the mounting portion 84 of the torsion bar 24 are disposed at substantially the same position as each other in the vehicle front-rear direction.

The first rotation section 34 is formed with a second hole portion 94. The second hole portion 94 is provided at the vehicle front side with respect to the first hole portion 92, and a vehicle front side end of the second hole portion 94 is open at a vehicle front side end of the second insertion portion 60 of the first rotation section 34. The second hole portion 94 has a circular inner circumferential profile, and the second hole portion 94 is disposed coaxially to the first hole portion 92. Moreover, the diameter dimension of an inner circumferential portion of the second hole portion 94 is set smaller than the diameter dimension of the inner circumferential portion of the first hole portion 92, and the vehicle rear side end of the second hole portion 94 opens onto the vehicle front side end of the first hole portion 92 (the bottom of the first hole portion 92), such that the second hole portion 94 is connected to the first hole portion 92.

As illustrated in FIG. 2 and FIG. 3A, the second rotation section 50 of the rotating member 32 is provided with a circular cylinder portion 96. The circular cylinder portion 96 is provided at the inside of the second rotation stop hole 58 of the second engagement portion 54, and is disposed coaxially to the spool 18. As illustrated in FIG. 3A and FIG. 6, a vehicle front side end of the circular cylinder portion 96 is connected to the second rotation section 50 so as to be integral with the second rotation section 50. Moreover, a vehicle rear side end of the circular cylinder portion 96 projects out toward the vehicle rear side than the vehicle rear side ends of the second engagement teeth 56 of the second rotation section 50 by a predetermined length.

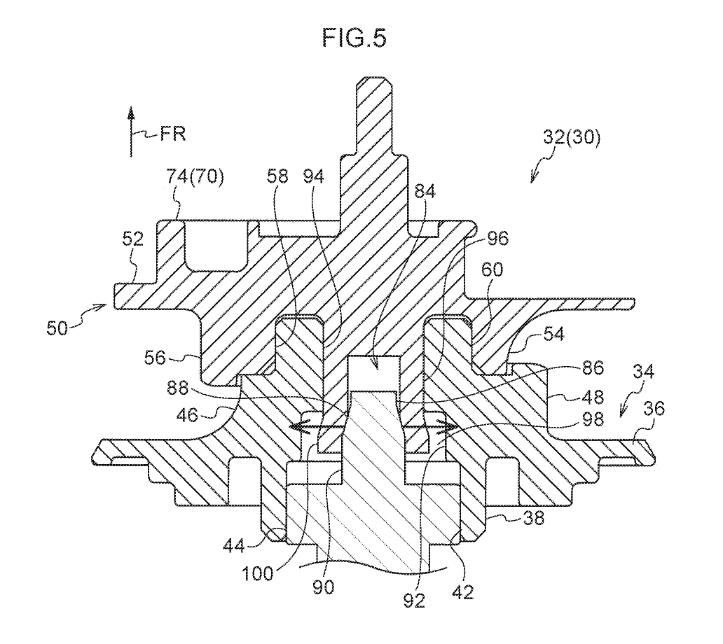

As illustrated in FIG. 4, the diameter dimension of an outer circumferential portion of the circular cylinder portion 96 in a state in which the torsion bar 24 is not mounted to the rotating member 32 is, overall, the same as the diameter dimension of the inner circumferential portion of the second hole portion 94 of the first rotation section 34 (strictly speaking, smaller than the diameter dimension of the inner circumferential portion of the second hole portion 94). The circular cylinder portion 96 is inserted into the second hole portion 94, and, furthermore, a vehicle rear side end portion of the circular cylinder portion 96 enters inside the first hole portion 92 in the first rotation section 34. In a state in which the vehicle rear side end portion of the circular cylinder portion 96 has entered inside the first hole portion 92, a space between the outer circumferential portion of the circular cylinder portion 96 and the inner circumferential portion of the first hole portion 92 configures a space 98.

As illustrated in FIG. 4, in a state in which the torsion bar 24 is not mounted to the rotating member 32, the diameter dimension of an inner circumferential portion of the circular cylinder portion 96 is more than the diameter dimension of the outer circumferential portion of the first circular column portion 86 of the mounting portion 84 of the torsion bar 24, and is less than the diameter dimension of the outer circumferential portion of the second circular column portion 90. Accordingly, as illustrated in FIG. 4, when mounting the torsion bar 24 to the rotating member 32, the first circular column portion 86 of the mounting portion 84 of the torsion bar 24 is able to enter inside the circular cylinder portion 96 from the vehicle rear side end of the circular cylinder portion 96. In a state in which the first circular column portion 86 has reached a predetermined position inside the circular cylinder portion 96, the outer circumferential portion of the taper portion 88 of the mounting portion 84 abuts the vehicle rear side end of the inner circumferential portion of the circular cylinder portion 96.

Moreover, as illustrated in FIG. 3A, FIG. 3B, and FIG. 6, a first detachment prevention portion 100, serving as a first restriction section, is formed to the circular cylinder portion 96 in a state in which the torsion bar 24 has been mounted to the rotating member 32. The first detachment prevention portion 100 is configured at a portion further to the vehicle rear side than a vehicle front-rear direction intermediate portion of the circular cylinder portion 96. A vehicle front side end of the first detachment prevention portion 100 abuts the vehicle front side end of the first hole portion 92 (the bottom of the first hole portion 92) from the vehicle rear side. The respective diameter dimensions of an outer circumferential portion and an inner circumferential portion of the first detachment prevention portion 100 are set larger than the respective diameter dimensions of an outer circumferential portion and an inner circumferential portion of portions of the circular cylinder portion 96, which are at a portion further to the vehicle front side than the first detachment prevention portion 100. Moreover, the diameter dimension of the inner circumferential portion of the first detachment prevention portion 100 is the same as the diameter dimension of the second circular column portion 90 of the mounting portion 84 of the torsion bar 24.

Note that at least the mounting portion 84 of the torsion bar 24 is made harder than at least the circular cylinder portion 96 of the second rotation section 50. In a state in which the outer circumferential portion of the taper portion 88 of the mounting portion 84 is abutted against the vehicle rear side end of the inner circumferential portion of the circular cylinder portion 96, when a pressing load exceeding the mechanical strength of the circular cylinder portion 96 (for example, the shear strength in a direction orthogonal to an axial direction (axial-orthogonal direction) of the circular cylinder portion 96) is imparted to the circular cylinder portion 96 from the taper portion 88 of the mounting portion 84, the circular cylinder portion 96 thus deforms from the vehicle rear side toward the outside in the axial-orthogonal direction of the circular cylinder portion 96 (a direction orthogonal to the vehicle front-rear direction). The first detachment prevention portion 100 is thereby formed to the circular cylinder portion 96.

Operation and Advantageous Effects of the First Exemplary Embodiment Next, explanation follows regarding operation of the webbing take-up device 10 during a vehicle emergency, such as a vehicle collision.

In the webbing take-up device 10, the sensor mechanism 80 is actuated in a vehicle emergency such as a vehicle collision. In an actuated state of the sensor mechanism 80, when, for example, the webbing 20 is pulled by the body of the occupant, thereby rotating the spool 18 in the pull-out direction and also rotating the rotating member 32 in the pull-out direction, the locking pawl 78 of the locking mechanism 70 is rotated in the locking direction (the arrow C direction in FIG. 1). The leading end portion of the locking pawl 78 therefore meshes with the ratchet teeth of the ratchet hole 76 in the cover plate 72, restricting rotation of the lock base 74 (namely, the rotating member 32) in the pull-out direction. By restricting pull-out direction rotation of the rotating member 32 in this manner, pull-out direction rotation of the spool 18 is also restricted, thus enabling the webbing 20 to be restricted from being pulled out from the spool 18, and enabling the body of the vehicle occupant to be restrained by the webbing 20.

In the webbing take-up device 10, in a vehicle collision, this being a mode of vehicle emergency, high pressure gas is supplied from the MGG 64 to inside the cylinder 62 the instant the MGG 64 of the pre-tensioner 30 is actuated by the ECU. When the ball seal 66 is moved toward the center axis direction leading end side of the cylinder 62 by the pressure of the gas, the moving member 68 is pressed by the ball seal 66, and the moving member 68 is moved toward the center axis direction leading end side of the cylinder 62.

Due to the moving member 68 being moved toward the center axis direction leading end side, the center axis direction leading end portion of the moving member 68 is moved out of the center axis direction leading end of the cylinder 62 toward the vehicle lower side. The moving member 68 that has moved out of the center axis direction leading end of the cylinder 62 toward the vehicle lower side in this manner, is moved inside the cover plate 72 while being guided by the cover plate 72. The moving member 68 accordingly enters between the first flange 36 and the second flange 52 of the rotating member 32, and the first engagement teeth 48 or the second engagement teeth 56 of the rotating member 32 are pressed toward the vehicle lower side by the axial direction leading end of the moving member 68. The rotating member 32 is thereby rotated in the take-up direction.

Moreover, due to the rotating member 32 rotating in the take-up direction, it is the first engagement teeth 48 or the second engagement teeth 56 that are further toward the pull-out direction side than the first engagement teeth 48 or the second engagement teeth 56 pressed by the axial direction leading end of the moving member 68 out of the plural first engagement teeth 48 and second engagement teeth 56 of the rotating member 32, that are the teeth that bite or stick into the moving member 68 from an outer circumferential face of the moving member 68 toward a radial direction central side of the moving member 68.

The rotating member 32 is rotated further toward the take-up direction by the moving member 68, into which the first engagement teeth 48 or the second engagement teeth 56 of the rotating member 32 are biting or sticking, being moved further toward the vehicle lower side. This take-up direction rotation of the rotating member 32 is transmitted to the spool 18 through the torsion bar 24, rotating the spool 18 in the take-up direction. The webbing 20 is thus taken up onto the spool 18, increasing the restraining force of the webbing 20 on the occupant.

In a state in which the leading end portion of the locking pawl 78 is meshed with the ratchet teeth of the ratchet hole 76 in the cover plate 72, when the webbing 20 is pulled toward its length direction leading end side, and a rotational force imparted to the spool 18 from the webbing 20 in the pull-out direction becomes greater than the mechanical strength against twisting of the rod 26 of the torsion bar 24 about its center axis, the rod 26 undergoes twisting deformation such that a vehicle rear side portion of the rod 26 is rotated in the pull-out direction with respect to a vehicle front side portion of the rod 26.

A portion of the pull-out direction rotational force imparted to the spool 18, namely a portion of the tensile force imparted to the webbing 20, is absorbed as the rod 26 undergoes twisting deformation, the spool 18 rotates in the pull-out direction, and the webbing 20 is pulled out from the spool 18, by an amount commensurate with the twisting deformation of the rod 26. The body of the occupant wearing the webbing 20 is thus able to move toward the vehicle front side by an amount corresponding to the length of the webbing 20 pulled out from the spool 18.

Next, explanation follows regarding assembly of the rotating member 32 of the webbing take-up device 10, and mounting of the torsion bar 24 to the rotating member 32.

First, in an opposition (facing)-placement process, the second insertion portion 60 of the first rotation section 34 is inserted inside the second rotation stop hole 58 in the second rotation section 50. The first rotation section 34 and the second rotation section 50 are thus disposed opposing (facing) each other along the vehicle front-rear direction, and relative rotation of the first rotation section 34 with respect to the second rotation section 50 is restricted. When the second insertion portion 60 is inserted into the second rotation stop hole 58 and a portion of the first rotation section 34 abuts the second rotation section 50 from the vehicle rear side, relative movement of the first rotation section 34 toward the vehicle front side with respect to the second rotation section 50 is prevented.

Next, in a mounting process, the mounting portion 84 of the torsion bar 24 is inserted into the first rotation stop hole 42 in the first rotation section 34 from the vehicle rear side, and then, the second coupling portion 44 of the torsion bar 24 is inserted into the first rotation stop hole 42 in the first rotation section 34. Relative rotation of the first rotation section 34 with respect to the torsion bar 24 is thereby restricted. In this manner, the first circular column portion 86 of the mounting portion 84 of the torsion bar 24 enters inside the first hole portion 92 in the first rotation section 34 and further the second hole portion 94 in the first rotation section 34 passing through the first rotation stop hole 42 in the first rotation section 34.

In this state, the circular cylinder portion 96 of the second rotation section 50 enters inside the second hole portion 94 of the first rotation section 34 and the vehicle rear side portion of the circular cylinder portion 96 of the second rotation section 50 enters inside the first hole portion 92 of the first rotation section 34. Accordingly, when a predetermined length or more of the first circular column portion 86 of the mounting portion 84 has entered inside the first hole portion 92 and further the second hole portion 94 of the first rotation section 34, the first circular column portion 86 enters inside the circular cylinder portion 96 through the vehicle rear side end of the circular cylinder portion 96 of the second rotation section 50.

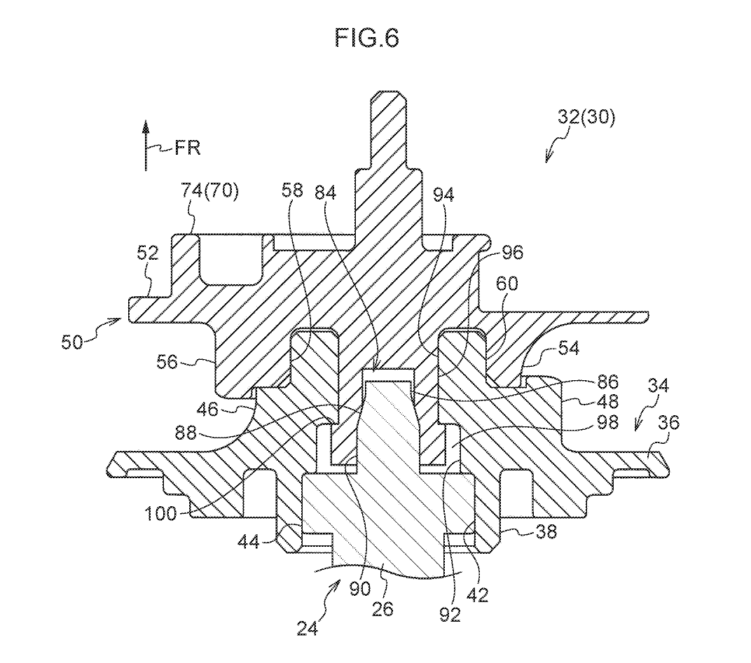

In this state, when the torsion bar 24 is moved further toward the vehicle front side relative to the rotating member 32, as illustrated in FIG. 4, the outer circumferential portion of the taper portion 88 of the mounting portion 84 abuts the vehicle rear side end of the inner circumferential portion of the circular cylinder portion 96. Note that at least the mounting portion 84 of the torsion bar 24 is made harder than at least the circular cylinder portion 96 of the second rotation section 50 of the rotating member 32. Accordingly, in this state, the inner circumferential portion of the circular cylinder portion 96 is pressed toward the axial-orthogonal direction outside of the circular cylinder portion 96 by the taper portion 88 of the mounting portion 84. When this pressing load becomes greater than the mechanical strength of the circular cylinder portion 96 (for example, the shear strength of the circular cylinder portion 96 in the axial-orthogonal direction), the circular cylinder portion 96 is deformed toward the axial-orthogonal direction outside from the vehicle rear side portion, such that in the circular cylinder portion 96, the diameter dimensions of both the inner circumferential portion and the outer circumferential portion of the circular cylinder portion 96 increase. The deformed portion of the circular cylinder portion 96 enters inside the space 98 which is inside of the first hole portion 92 of the first rotation section 34 (see FIG. 5).

Next, as illustrated in FIG. 6, the vehicle front side end of the second coupling portion 44 of the torsion bar 24 is abutted against the vehicle front side end of the first rotation stop hole 42 (bottom of the first rotation stop hole 42), thereby mounting the torsion bar 24 to the rotating member 32. Note that the vehicle front-rear direction dimensions and the like of the first hole portion 92 and the second circular column portion 90 are set such that, in this state, the vehicle rear side end of the first hole portion 92 of the first rotation section 34 and the vehicle rear side end of the second circular column portion 90 of the mounting portion 84 of the torsion bar 24 are disposed at substantially the same position as each other in the vehicle front-rear direction. Accordingly, the deformed portion of the circular cylinder portion 96, which is formed by the circular cylinder portion 96 being pressed by the taper portion 88 of the mounting portion 84, abuts the vehicle front side end of the first hole portion 92 (the bottom of the first hole portion 92) from the vehicle rear side in a mounted state of the torsion bar 24 to the rotating member 32. This thereby forms the first detachment prevention portion 100 on the circular cylinder portion 96.

In this state, if the second rotation section 50 attempts to move toward the vehicle front side relative to the first rotation section 34, relative movement toward the vehicle front side of the first detachment prevention portion 100 of the circular cylinder portion 96 of the second rotation section 50 is restricted by the bottom of the first hole portion 92 in the first rotation section 34. This thereby enables relative movement of the second rotation section 50 toward the vehicle front side with respect to the first rotation section 34 to be restricted. Namely, the first rotation section 34 and the second rotation section 50 can be restricted from moving apart from each other in the vehicle front-rear direction.

Moreover, in a state in which the first detachment prevention portion 100 is formed to the circular cylinder portion 96, the mounting portion 84 of the torsion bar 24 enters inside the first detachment prevention portion 100. Deformation of the first detachment prevention portion 100 toward the radial direction inside is thus suppressed by the mounting portion 84. This thereby enables the shape of the first detachment prevention portion 100 to be maintained, and enables the coupling between the first rotation section 34 and the second rotation section 50 to be maintained.

Note that, for example, the first flange 36 and the second flange 52 may be pressed in directions away from each other in the vehicle front-rear direction by the moving member 68 when the pre-tensioner 30 is actuated and the moving member 68 enters between the first flange 36 of the first rotation section 34 and the second flange 52 of the second rotation section 50. In such a case, since the first detachment prevention portion 100 is formed to the circular cylinder portion 96 of the second rotation section 50, and moreover, deformation of the first detachment prevention portion 100 toward the radial direction inside is suppressed by the mounting portion 84 of the torsion bar 24, enabling the first rotation section 34 and the second rotation section 50 to be restricted from moving apart from each other, and enabling the coupling between the first rotation section 34 and the second rotation section 50 to be maintained.

In this manner, in the present exemplary embodiment, the first rotation section 34 and the second rotation section 50 of the rotating member 32 can be assembled together by mounting the torsion bar 24 to the rotating member 32. This thereby enables an increase in the number of assembly processes of the rotating member 32, and an increase in the number of processes to mount the torsion bar 24 onto the rotating member 32, to be suppressed.

Moreover, since the first detachment prevention portion 100 is formed by deforming the circular cylinder portion 96, the torsion bar 24 is necessary but there is no need for any tools such as a punch. There is accordingly no need for shape control (maintenance) for wear or the like at the portion of such a tool contacting the circular cylinder portion 96, enabling a reduction in costs.

Moreover, in a case in which the first detachment prevention portion 100 is formed by deforming the circular cylinder portion 96 using a tool such as a punch, it would, for example, be necessary to visually confirm whether the first detachment prevention portion 100 had been formed (whether the circular cylinder portion 96 had deformed enough such that the first detachment prevention portion 100 abuts the bottom of the first hole portion 92 in the first rotation section 34 from the vehicle rear side). By contrast, as illustrated in FIG. 6, in the present exemplary embodiment, the vehicle front-rear direction dimensions and the like of the first hole portion 92 and the second circular column portion 90 are set such that the vehicle rear side end of the first hole portion 92 of the first rotation section 34 is disposed at substantially the same position in the vehicle front-rear direction as the vehicle rear side end of the second circular column portion 90 of the torsion bar 24, in a state in which the vehicle front side end of the second coupling portion 44 of the torsion bar 24 has abutted the vehicle front side end of the first rotation stop hole 42 (the bottom of the first rotation stop hole 42) (namely, in a mounted state of the torsion bar 24 to the rotating member 32).

Accordingly, the deformed portion (namely, the first detachment prevention portion 100) of the circular cylinder portion 96 of the second rotation section 50, which is deformed by pressing with the outer circumferential portion of the taper portion 88 of the mounting portion 84 of the torsion bar 24, abuts the bottom of the first hole portion 92 of the first rotation section 34 in a state in which the torsion bar 24 has been mounted to the rotating member 32. There is thus no need to confirm whether or not the first detachment prevention portion 100 is abutting the bottom of the first hole portion 92, enabling a reduction in processes required when carrying out such confirmation to be reduced, and enabling lower costs to be achieved.

Second Exemplary Embodiment Configuration Next, explanation follows regarding a second exemplary embodiment. Note that in the explanation regarding the second exemplary embodiment, locations that are basically equivalent to those of the first exemplary embodiment are allocated the same reference numerals thereto, and detailed explanation thereof is omitted.

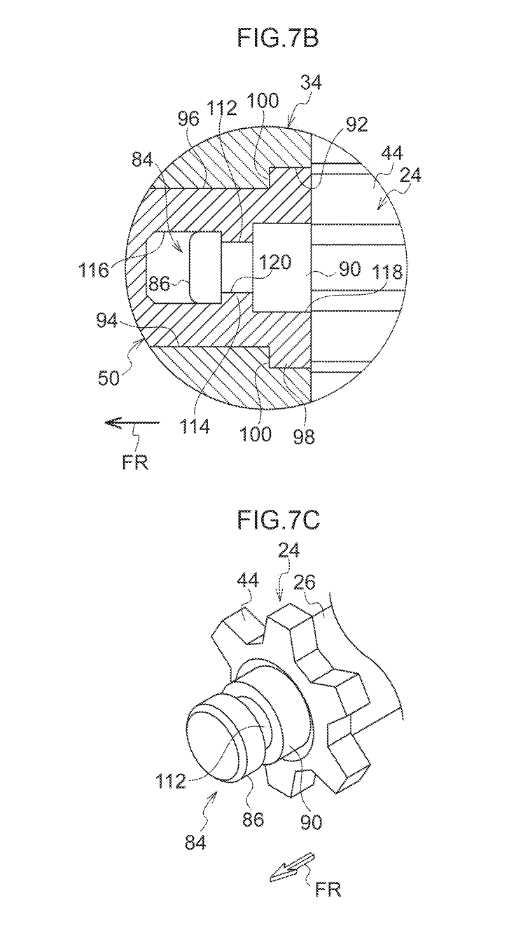

In the present exemplary embodiment, as illustrated in FIG. 7A to FIG. 7C, the mounting portion 84 of the torsion bar 24 is provided with a third circular column portion 112 instead of the taper portion 88. The third circular column portion 112 is configured with a circular column shape, and is disposed coaxially to the first circular column portion 86 and the second circular column portion 90. The diameter dimension of an outer circumferential portion of the third circular column portion 112 is smaller than the diameter dimension of the outer circumferential portion of the first circular column portion 86. A ring-shaped housing groove 114, serving as a housing portion, is thus formed at the outside of the outer circumferential portion of the third circular column portion 112 and at the vehicle rear side with respect to the vehicle rear side end of the first circular column portion 86. In the present exemplary embodiment, at least the second coupling portion 44 and the mounting portion 84 of the torsion bar 24 are made harder than the circular cylinder portion 96 of the second rotation section 50.

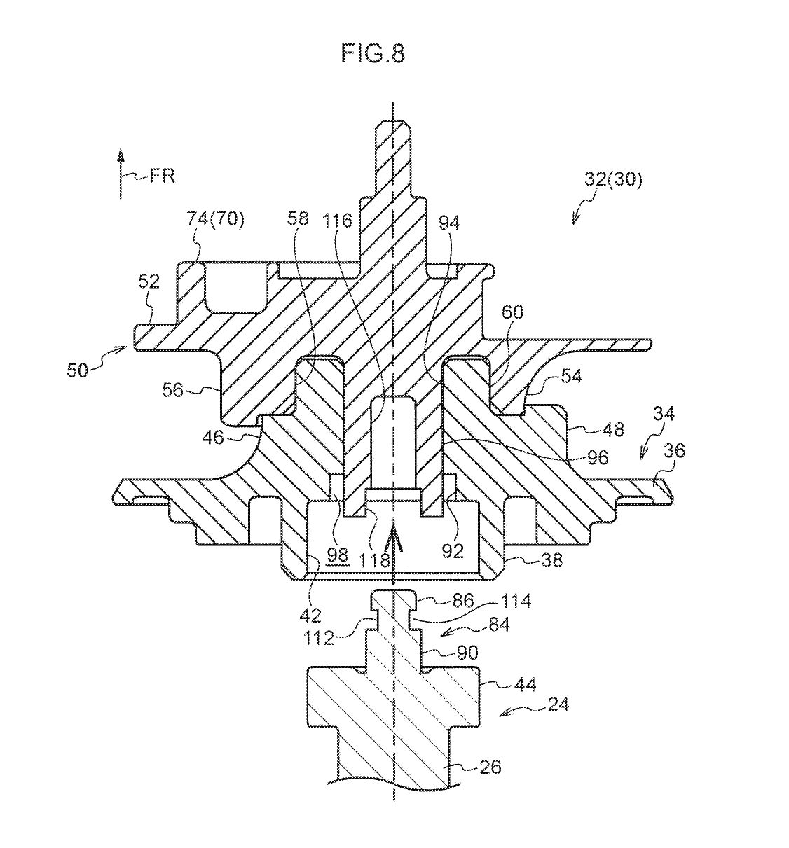

Moreover, as illustrated in FIG. 8, in the present exemplary embodiment, the circular cylinder portion 96 is provided with a small diameter portion 116 and a large diameter portion 118 when in a state prior to mounting the torsion bar 24 to the rotating member 32. The small diameter portion 116 configures a vehicle front side portion of the circular cylinder portion 96, and the large diameter portion 118 configures a vehicle rear side portion of the circular cylinder portion 96. A vehicle rear side end of the small diameter portion 116 is directly connected to a vehicle front side end of the large diameter portion 118. Moreover, the diameter dimension of an outer circumferential portion of the small diameter portion 116 is the same as the diameter dimension of an outer circumferential portion of the large diameter portion 118, and the outer circumferential portion of the small diameter portion 116 is disposed coaxially to the outer circumferential portion of the large diameter portion 118. The diameter dimension of an inner circumferential portion of the small diameter portion 116 is smaller than the diameter dimension of the inner circumferential portion of the large diameter portion 118, and the inner circumferential portion of the small diameter portion 116 is disposed coaxially to the inner circumferential portion of the large diameter portion 118.

Moreover, the diameter dimension of the inner circumferential portion of the small diameter portion 116 is the same as the diameter dimension of the outer circumferential portion of the first circular column portion 86 of the mounting portion 84 of the torsion bar 24 (strictly speaking, smaller than the diameter dimension of the outer circumferential portion of the first circular column portion 86), and the first circular column portion 86 is capable of being inserted inside the small diameter portion 116 of the circular cylinder portion 96. The diameter dimension of the inner circumferential portion of the large diameter portion 118 is the same as the diameter dimension of the outer circumferential portion of the second circular column portion 90 of the mounting portion 84 of the torsion bar 24 (strictly speaking, smaller than the diameter dimension of the outer circumferential portion of the second circular column portion 90), and the second circular column portion 90 is capable of being inserted inside the large diameter portion 118 of the circular cylinder portion 96. Accordingly, the vehicle front side end of the second circular column portion 90 opposes (faces) the vehicle rear side end of the small diameter portion 116 of the circular cylinder portion 96 in the vehicle front-rear direction in a state in which the second circular column portion 90 has been inserted inside the large diameter portion 118 of the circular cylinder portion 96.

The vehicle front-rear direction length of the second circular column portion 90 is longer than the vehicle front-rear direction length of the large diameter portion 118 of the circular cylinder portion 96. Accordingly, when the second coupling portion 44 of the torsion bar 24 has been inserted into the first rotation stop hole 42 in the first rotation section 34, the vehicle front side end of the second circular column portion 90 abuts a vehicle rear side end of the small diameter portion 116 in a state in which the vehicle front side end of the second coupling portion 44 is separated from the vehicle front side end of the first rotation stop hole 42 (the bottom of the first rotation stop hole 42).

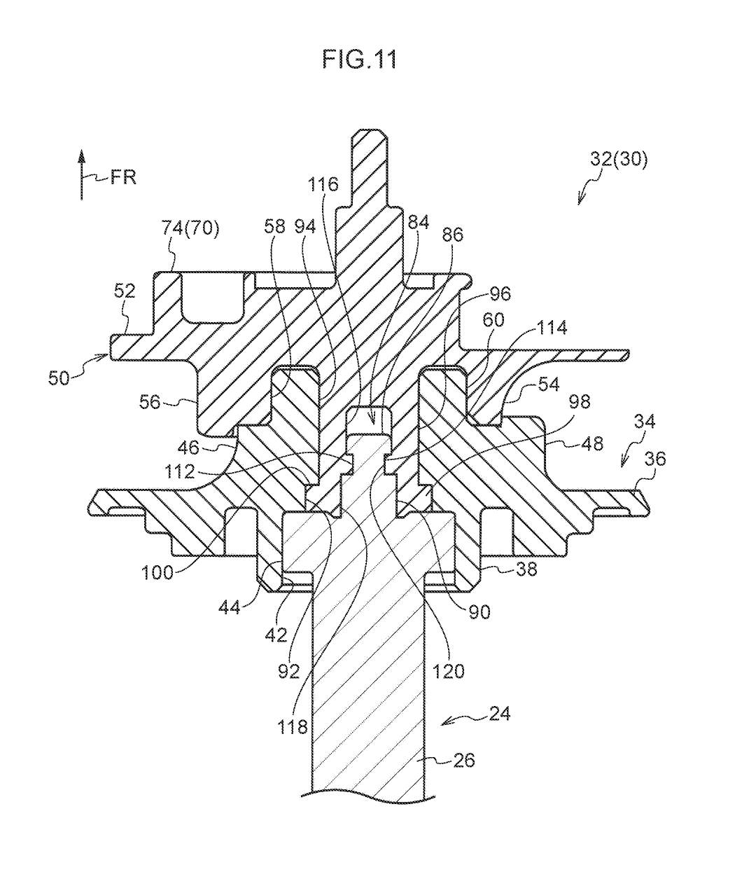

Moreover, in the present exemplary embodiment, as illustrated in FIG. 7A, FIG. 7B, and FIG. 11, the first detachment prevention portion 100 and a second detachment prevention portion 120, serving as a second restriction section, are formed on the circular cylinder portion 96 in a state in which the torsion bar 24 has been mounted to the rotating member 32. In the present exemplary embodiment, the volume of the first detachment prevention portion 100 is substantially the same as the capacity of the space 98, such that the space 98 is filled by the first detachment prevention portion 100. Moreover, in contrast to the first exemplary embodiment, in the present exemplary embodiment, the first detachment prevention portion 100 is formed by deforming the large diameter portion 118 such that the vehicle rear side end of the large diameter portion 118 of the circular cylinder portion 96 is pressed by the vehicle front side end of the second coupling portion 44 of the torsion bar 24.

The second detachment prevention portion 120 enters inside the housing groove 114 of the mounting portion 84. The second detachment prevention portion 120 is formed by the small diameter portion 116 deforming such that the vehicle rear side end of the small diameter portion 116 of the circular cylinder portion 96 is pressed by the vehicle front side end of the second circular column portion 90 of the mounting portion 84 of the torsion bar 24. Note that the volume of the second detachment prevention portion 120, namely the volume of a deformed portion of the small diameter portion 116 of the circular cylinder portion 96, which deformation is caused by the second circular column portion 90 of the mounting portion 84 of the torsion bar 24, from a time when the vehicle front side end of the second coupling portion 44 of the torsion bar 24 abutting the vehicle rear side end of the large diameter portion 118 of the circular cylinder portion 96 to a time when the vehicle front side end of the second coupling portion 44 abutting the vehicle front side end of the first rotation stop hole 42 in the first rotation section 34 of the rotating member 32 (the bottom of the first rotation stop hole 42), is substantially the same as the capacity of the housing groove 114, such that the housing groove 114 is filled by the second detachment prevention portion 120.

Operation and Advantageous Effects of the Second Exemplary Embodiment Next, explanation follows regarding assembly of the webbing take-up device 10 to the rotating member 32 and mounting of the torsion bar 24 to the rotating member 32.

First, in an opposition (facing)-placement process, the second insertion portion 60 of the first rotation section 34 is inserted inside the second rotation stop hole 58 of the second rotation section 50. The first rotation section 34 and the second rotation section 50 are thus disposed opposing (facing) each other along the vehicle front-rear direction, and relative rotation of the first rotation section 34 with respect to the second rotation section 50 is restricted (see FIG. 8).

Next, in a mounting process, the mounting portion 84 of the torsion bar 24 is inserted into the first rotation stop hole 42 of the first rotation section 34 from the vehicle rear side, and the second coupling portion 44 of the torsion bar 24 is then inserted into the first rotation stop hole 42 of the first rotation section 34. Relative rotation of the first rotation section 34 with respect to the torsion bar 24 is thereby restricted.

Moreover, in this state, the vehicle rear side portion of the circular cylinder portion 96 of the second rotation section 50 enters inside the first rotation stop hole 42 in the first rotation section 34 passing through the second hole portion 94 in the first rotation section 34. Accordingly, when a predetermined length or more of the first circular column portion 86 of the mounting portion 84 has entered inside the second hole portion 94 in the first rotation section 34 passing through the first rotation stop hole 42 in the first rotation section 34, the first circular column portion 86 enters inside the circular cylinder portion 96 from the vehicle rear side end of the circular cylinder portion 96. When the second coupling portion 44 of the torsion bar 24 is inserted further into the first rotation stop hole 42 of the first rotation section 34 from this state, the vehicle front side end of the second circular column portion 90 of the mounting portion 84 of the torsion bar 24 abuts the vehicle rear side end of the small diameter portion 116 of the circular cylinder portion 96 of the second rotation section 50.

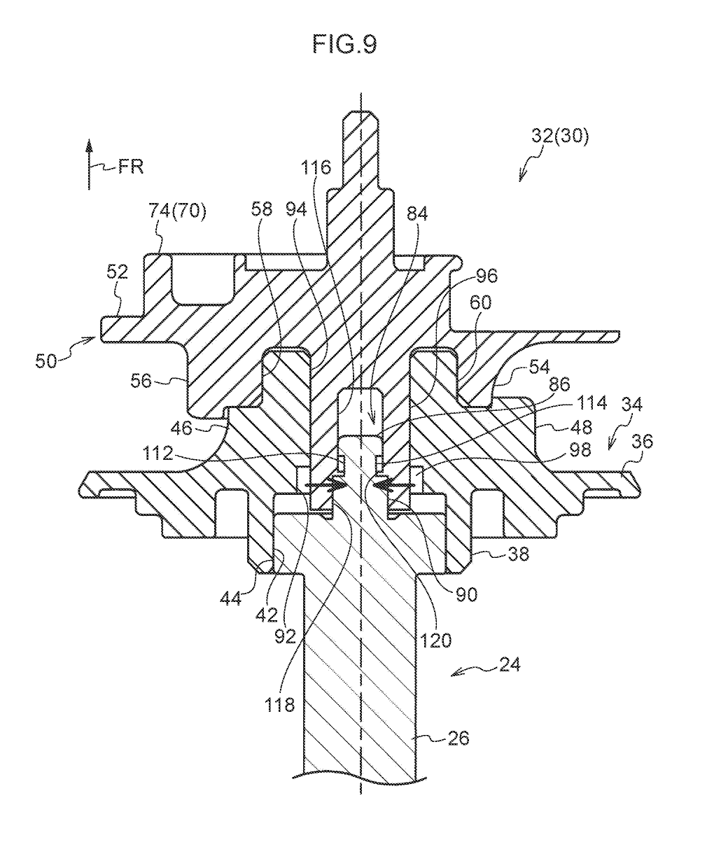

Note that at least the second coupling portion 44 and the mounting portion 84 of the torsion bar 24 are made harder than at least the circular cylinder portion 96 of the second rotation section 50 of the rotating member 32. Accordingly, in this state, the vehicle rear side end of the small diameter portion 116 of the circular cylinder portion 96 is pressed by the vehicle front side end of the second circular column portion 90 of the mounting portion 84. When this pressing load becomes greater than the mechanical strength of the circular cylinder portion 96 (for example, the shear strength of the circular cylinder portion 96 in the axial-orthogonal direction) then, as illustrated in FIG. 9, the small diameter portion 116 of the circular cylinder portion 96 is deformed toward the radial direction inside from the vehicle rear side. The deformed portion of the small diameter portion 116 enters inside the housing groove 114.

Moreover, due to the second coupling portion 44 of the torsion bar 24 being inserted into the first rotation stop hole 42 of the first rotation section 34, the vehicle front side end of the second coupling portion 44 abuts the vehicle rear side end of the circular cylinder portion 96 (the large diameter portion 118). Note that at least the second coupling portion 44 and the mounting portion 84 of the torsion bar 24 are made harder than at least the circular cylinder portion 96 of the second rotation section 50 of the rotating member 32.

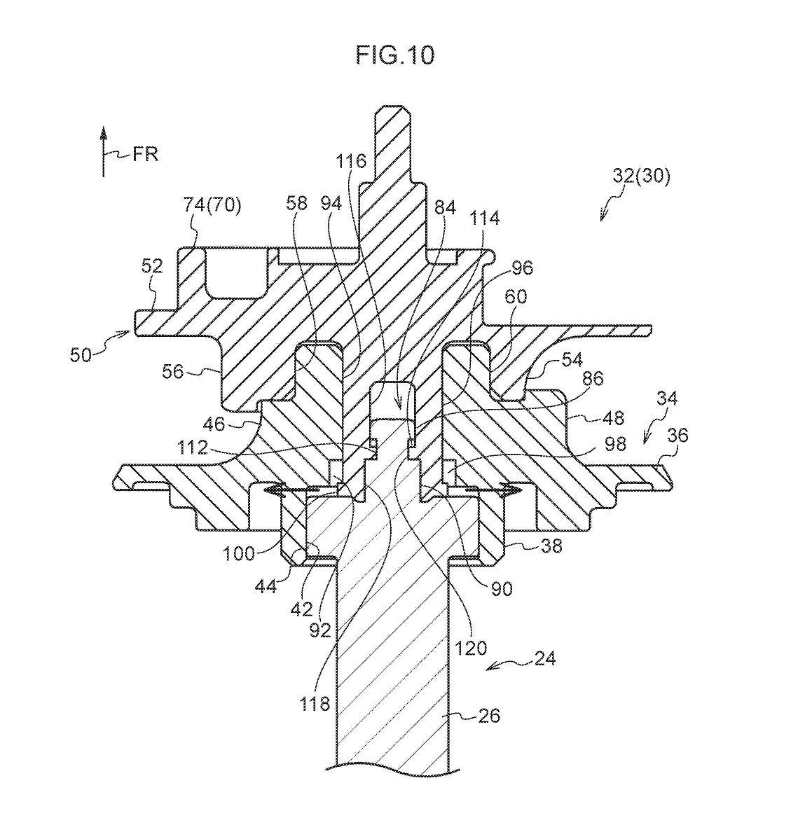

Accordingly, in this state, the vehicle rear side end of the circular cylinder portion 96 (the large diameter portion 118) is pressed by the vehicle front side end of the second coupling portion 44 of the torsion bar 24. When this pressing load becomes greater than the mechanical strength of the circular cylinder portion 96 (for example, the shear strength of the circular cylinder portion 96 in the axial-orthogonal direction) then, as illustrated in FIG. 10, the circular cylinder portion 96 is deformed from the vehicle rear side. Moreover, in this state, the second circular column portion 90 of the mounting portion 84 enters inside the vehicle rear side end portion of the circular cylinder portion 96, restricting deformation of the vehicle rear side portion of the circular cylinder portion 96 toward the radial direction inside. Accordingly, the vehicle rear side portion of the circular cylinder portion 96 is deformed toward the radial direction outside of the circular cylinder portion 96 at the inside of the space 98, due to being pressed by the vehicle front side end of the second coupling portion 44 of the torsion bar 24.

Moreover, as illustrated in FIG. 11, the torsion bar 24 is mounted to the rotating member 32, and at the circular cylinder portion 96 of the second rotation section 50, the first detachment prevention portion 100 and the second detachment prevention portion 120 are formed, by the vehicle front side end of the second coupling portion 44 of the torsion bar 24 being abutted against the vehicle front side end of the first rotation stop hole 42 (the bottom of the first rotation stop hole 42).

Note that the volume of the first detachment prevention portion 100 is substantially the same as the capacity of the space 98, such that the space 98 is filled by the first detachment prevention portion 100. Accordingly, the vehicle front side end of the first detachment prevention portion 100 is abutted against the vehicle front side end of the first hole portion 92 in the first rotation section 34 (the bottom of the first hole portion 92). Accordingly, relative movement of the second rotation section 50 toward the vehicle front side with respect to the first rotation section 34 is restricted. Namely, the first rotation section 34 and the second rotation section 50 are restricted from moving apart from each other in the vehicle front-rear direction.

The volume of the second detachment prevention portion 120 of the circular cylinder portion 96 is substantially the same as the capacity of the housing groove 114, and the housing groove 114 is filled by the second detachment prevention portion 120. Accordingly, a vehicle rear side end of the second detachment prevention portion 120 abuts a vehicle rear side end of the housing groove 114 (the vehicle front side end of the second circular column portion 90 of the mounting portion 84). Accordingly, in this state, relative movement of the torsion bar 24 toward the vehicle rear side with respect to the second rotation section 50 is restricted. Namely, movement of the torsion bar 24 in the manner to separate the torsion bar 24 from the rotating member 32 is restricted.

Forming the first detachment prevention portion 100 and the second detachment prevention portion 120 to the circular cylinder portion 96 as described above enables the first rotation section 34 and the second rotation section 50 to be restricted from moving away from each other in the vehicle front-rear direction, and enables the coupling between the first rotation section 34 and the second rotation section 50 to be maintained. Accordingly, the present exemplary embodiment enables similar advantageous effects to be obtained to those of the first exemplary embodiment.

Moreover, as described above, forming the second detachment prevention portion 120 to the circular cylinder portion 96 enables movement of the torsion bar 24 in the manner to separate the torsion bar 24 from the rotating member 32 to be restricted. Accordingly, for example, this lessens the need for careful handling of the rotating member 32, the torsion bar 24 and the like such that the torsion bar 24 does not separate from the rotating member 32 in each manufacturing process of the webbing take-up device 10 subsequent to mounting the torsion bar 24 to the rotating member 32. This thereby enables the number of manufacturing processes of the webbing take-up device 10 to be reduced, and enables lower costs to be achieved.

Moreover, in the present exemplary embodiment, the vehicle rear side end of the circular cylinder portion 96 of the second rotation section 50 is deformed by being pressed by the vehicle front side end of the second coupling portion 44, this being an example of a portion different to the mounting portion 84 of the torsion bar 24, to form the first detachment prevention portion 100 on the circular cylinder portion 96. Forming the first detachment prevention portion 100 on the circular cylinder portion 96 in this manner thus enables deformation and the like of the mounting portion 84 of the torsion bar 24 to be suppressed.

Note that in each of the exemplary embodiments described above, in the mounting process to mount the torsion bar 24, serving as a mounted member, to the rotating member 32, the circular cylinder portion 96 of the second rotation section 50 is deformed by the mounting portion 84 of the torsion bar 24 so as to form the first detachment prevention portion 100 serving as a first restriction section, the second detachment prevention portion 120 serving as a second restriction section, or the like. However, there is no need for a mounted member to deform the first rotation section 34 or the second rotation section 50 to form the first restriction section, the second restriction section, or the like, and it is sufficient that the mounted member be capable of suppressing deformation of a first restriction section, a second restriction section, or the like by being mounted to the rotating member.

Moreover, in each of the exemplary embodiments described above, the first detachment prevention portion 100 serving as a first restriction section, and the second detachment prevention portion 120 serving as a second restriction section, or the like, are formed by deforming the circular cylinder portion 96 of the second rotation section 50. However, for example, a first restriction section, a second restriction section, or the like may be configured by a different component to the second rotation section 50, and the first restriction section, the second restriction section, or the like are not limited to configurations formed by deformation of the first detachment prevention portion 100 or the second detachment prevention portion 120.

Moreover, in each of the exemplary embodiments described above, the torsion bar 24, serving as an energy absorption member, configures a mounted member. However, a mounted member may be configured another member of an energy absorption member.

Moreover, each of the exemplary embodiments described above includes the single moving member 68 in the pre-tensioner 30. However, configuration may be made in which plural of the moving members 68 are provided in a row along the center axis direction of the cylinder 62 of the pre-tensioner 30. Moreover, in each of the exemplary embodiments described above, the moving member 68 has a circular column shape. However, for example, the moving member 68 may be configured with a spherical shape, and there are no particular limitations regarding the shape of the moving member 68.

What is claimed is:

1. A webbing take-up device comprising:
a spool that takes up a webbing by being rotated in a take-up direction;
a first rotation section that rotates the spool in the take-up direction by being rotated in a predetermined direction;
a second rotation section that opposes the first rotation section, and that is connected to the first rotation section so as to be capable of rotating integrally with the first rotation section;
a first restriction section that is provided at one of the first rotation section or the second rotation section, that restricts relative movement of the first rotation section and the second rotation section in a direction away from each other, and that couples the first rotation section and the second rotation section; and
a mounted member that is mounted to the one of the first rotation section or the second rotation section, and that suppresses deformation of the first restriction section.

2. The webbing take-up device of claim 1, wherein the first restriction section is configured by a deformation portion of the one of the first rotation section or the second rotation section.

3. The webbing take-up device of claim 2, wherein the first restriction section is configured by the deformation portion of the one of the first rotation section or the second rotation section, which is deformed by the mounted member.

4. The webbing take-up device of claim 1, wherein the mounted member is deformed by rotation of the spool in a pull-out direction that is opposite from the take-up direction, whereby the mounted member absorbs rotational force of the spool in the pull-out direction.

5. The webbing take-up device of claim 3, wherein the mounted member is deformed by rotation of the spool in a pull-out direction that is opposite from the take-up direction, whereby the mounted member absorbs rotational force of the spool in the pull-out direction.

6. The webbing take-up device of claim 1, wherein the first restriction section is configured by a deformation portion of the one of the first rotation section or the second rotation section, which is deformed in a direction orthogonal to a rotation axis of the one of the first rotation section or the second rotation section by the mounted member.

7. The webbing take-up device of claim 5, wherein the first restriction section is configured by a deformation portion of the one of the first rotation section or the second rotation section, which is deformed in a direction orthogonal to a rotation axis of the one of the first rotation section or the second rotation section by the mounted member.

8. The webbing take-up device of claim 1, wherein the first restriction section is configured by a deformation portion of the one of the first rotation section or the second rotation section, which is deformed by a portion of the mounted member that is different from a mounted portion of the mounted member, the mounted portion being mounted to the one of the first rotation section or the second rotation section.

9. The webbing take-up device of claim 1, further comprising a second restriction section that restricts movement of the mounted member in an opposite direction from a mounting direction of the mounted member with respect to the one of the first rotation section or the second rotation section in a mounted state of the mounted member to the one of the first rotation section or the second rotation section.

10. The webbing take-up device of claim 8, further comprising a second restriction section that restricts movement of the mounted member in an opposite direction from a mounting direction of the mounted member with respect to the one of the first rotation section or the second rotation section in a mounted state of the mounted member to the one of the first rotation section or the second rotation section.

11. The webbing take-up device of claim 9, wherein the mounted member includes a housing portion that houses the second restriction section, and the second restriction section opposes the mounted member from a side that is opposite from the mounting direction, in a state in which the second restriction section is housed in the housing portion.

12. The webbing take-up device of claim 10, wherein the mounted member includes a housing portion that houses the second restriction section, and the second restriction section opposes the mounted member from a side that is opposite from the mounting direction, in a state in which the second restriction section is housed in the housing portion.

13. The webbing take-up device of claim 9, wherein the second restriction section is configured by another deformation portion of one of the first rotation section or the second rotation section.

14. The webbing take-up device of claim 12, wherein the second restriction section is configured by another deformation portion of one of the first rotation section or the second rotation section.

15. The webbing take-up device of claim 13, wherein the second restriction section is configured by the another deformation portion of the one of the first rotation section or the second rotation section, which is deformed by the mounted member.

16. The webbing take-up device of claim 14, wherein the second restriction section is configured by the another deformation portion of the one of the first rotation section or the second rotation section, which is deformed by the mounted member.

17. A manufacturing method of a webbing take-up device, the webbing take-up device including:
a spool that takes up a webbing by being rotated in a take-up direction;
a first rotation section that rotates the spool in the take-up direction by being rotated in a predetermined direction;
a second rotation section that opposes the first rotation section, and that is connected to the first rotation section so as to be capable of rotating integrally with the first rotation section;
a first restriction section that is provided at one of the first rotation section or the second rotation section, that restricts relative movement of the first rotation section and the second rotation section in a direction away from each other, and that couples the first rotation section and the second rotation section; and
a mounted member that is mounted to the one of the first rotation section or the second rotation section, that suppresses deformation of the first restriction section, and that is deformed by rotation of the spool in a pull-out direction that is opposite from the take-up direction, whereby the mounted member absorbs rotational force of the spool in the pull-out direction,
the manufacturing method comprising:
mounting the mounted member to the one of the first rotation section or the second rotation section in a state in which the first rotation section and the second rotation section are disposed opposing each other; and
by mounting the mounted member to the one of the first rotation section or the second rotation section, deforming the one of the first rotation section or the second rotation section to form the first restriction section so as to suppress deformation of the first restriction section.
